(19) United States
(12) Patent Application Publication
(10) Pub. No.: US 2012/0028085 A1
(43) Pub. Date: Feb. 2, 2012

(54) LITHIUM ION BATTERY FOR RAILROAD LOCOMOTIVE

(76) Inventor: James Wurth, Las Vegas, NV (US)

(21) Appl. No.: 13/177,163

(22) Filed: Jul. 6, 2011

Related U.S. Application Data
(60) Provisional application No. 61/362,569, filed on Jul. 8, 2010.

(51) Int. Cl. H01M 10/42; B23P 11/00

(52) U.S. Cl. 429/7; 29/428

(57) ABSTRACT

Battery apparatus for use in starting railroad locomotives includes a portable housing. A Lithium Iron Phosphate chemistry Lithium ion battery is carried within the housing. The battery has a positive output lead and a negative output lead accessible from the exterior of the housing. A low voltage and high voltage protection module is positioned within the housing and connected to the positive output lead and the negative output lead. The module is constructed to switch the battery into a “sleeping mode” when the battery voltage reaches a low voltage or a high voltage condition. Output terminals are mounted on an exterior surface of the housing in a location available to be connected to a locomotive by interconnecting cables. When the voltage protection module switches the battery into the “sleeping mode” a push button on the housing is used to reactivate the apparatus.

### CROSS-REFERENCE TO RELATED APPLICATION

This application claims the benefit of U.S. Provisional Patent Application No. 61/362,569, filed 8 Jul. 2010.

### FIELD OF THE INVENTION

This invention relates to starter batteries for railroad locomotives.

More particularly, the present invention relates to improved starter batteries for railroad locomotives.

### BACKGROUND OF THE INVENTION

In the present day, lead acid batteries are used for starting locomotives as up until now no other battery technology was available. One major problem with lead acid batteries for use in starting locomotives is the fact that they weigh thousands of pounds and require two 32 volt units tied in series for a common 64 volt battery unit. Another problem is that lead acid batteries do not fare well with deep discharges, which can occur rather frequently. In addition sulfation occurs when the batteries are not kept fully charged. Further, lead acid batteries require substantial amounts of time to recharge. All of this, results in significantly shortened life cycles for lead acid locomotive starter batteries. Also, these batteries require periodic maintenance to maintain water levels.

Some attempts have been made to substitute Lithium ion batteries based on cobalt chemistry (LiCoO₂ or LCO) for the lead acid batteries. However, the cobalt type batteries are thermally unstable and are prone to thermal runaway. The thermal runaway is highly unsatisfactory since it can cause fires, explosions, and harm to personnel adjacent thereto.

It would be highly advantageous, therefore, to remedy the foregoing and other deficiencies inherent in the prior art.

An object of the present invention is to provide new and improved safe Lithium ion battery starting apparatus for railroad locomotives.

Another object of the present invention is to provide Lithium ion battery starting apparatus for railroad locomotives that is smaller and relatively easy to handle. Another object of the present invention is to provide Lithium ion battery starting apparatus for railroad locomotives with three to five times the life cycle of lead acid batteries.

Another object of the present invention is to provide Lithium ion battery starting apparatus for railroad locomotives in which the batteries can be quickly recharged and/or changed and easily replaced in a matter of minutes.

Another object of the present invention is to provide Lithium ion battery starting apparatus for railroad locomotives that requires no or substantially reduced maintenance.

### SUMMARY OF THE INVENTION

Briefly, to achieve the desired objects of the instant invention in accordance with a preferred embodiment thereof, provided is battery starting apparatus for railroad locomotives that is portable and requires substantially no maintenance. A Lithium Iron Phosphate chemistry Lithium ion battery is carried within a housing. The battery has a positive output lead and a negative output lead accessible from the exterior of the housing. A low voltage and high voltage protection module is positioned within the housing and connected to the positive output lead and the negative output lead. The module is constructed to switch the battery into a “sleeping mode” when the battery voltage reaches a low voltage or a high voltage condition. A pair of output terminals is connected to the positive output lead and the negative output lead. The output terminals are mounted on an exterior surface of the housing in a location available to be connected to a locomotive by interconnecting cables.

In another aspect of the present invention, a method of connecting a battery to a railroad locomotive for starting the locomotive includes the step of providing Lithium Iron Phosphate chemistry Lithium ion battery starting apparatus carried within a housing, the battery starting apparatus including a positive output lead and a negative output lead accessible from the exterior of the housing, a low voltage and high voltage protection module positioned within the housing and connected to the positive output lead and the negative output lead, the module being constructed to switch the battery into a “sleeping mode” when the battery voltage reaches either a low or a high voltage condition, and a pair of output terminals connected to the positive output lead and the negative output lead. The method further includes connecting the battery apparatus to a locomotive by interconnecting cables coupled between the locomotive and the pair of output terminals.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a perspective view of Lithium ion battery apparatus for railroad locomotives in accordance with the present invention;

FIG. 2A is a wiring diagram of the Lithium ion battery apparatus of FIG. 1;

FIG. 2b is a more detailed portion of the wiring diagram of FIG. 2A; and

FIG. 3 is a graphical presentation of the voltage drop versus load of the Lithium ion battery of FIG. 1.

### DETAILED DESCRIPTION OF THE PREFERRED EMBODIMENT

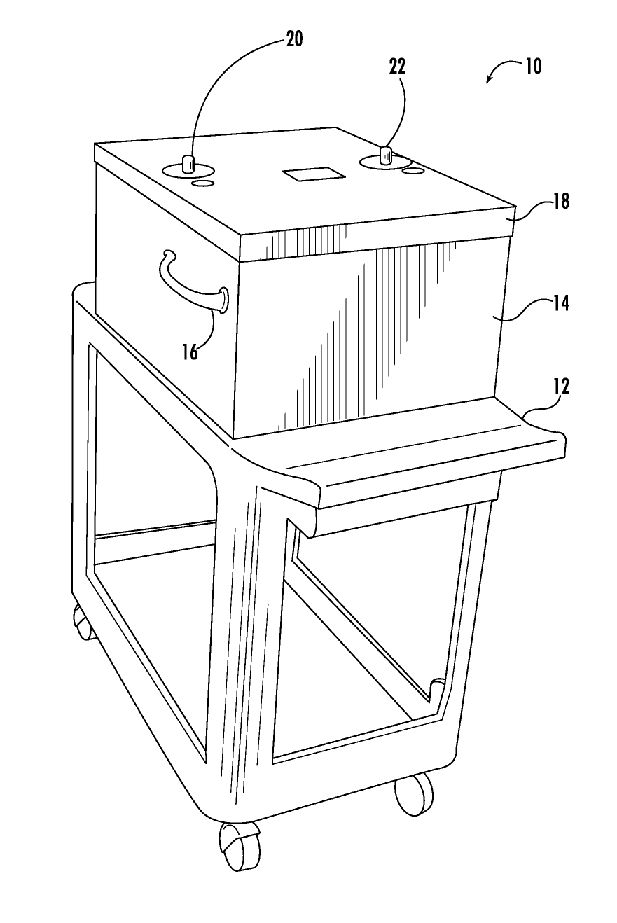

Turning now to the drawings in which like reference characters indicate corresponding elements throughout the several views, attention is first directed to FIG. 1 which illustrates Lithium ion battery apparatus 10 for starting railroad locomotives in accordance with the present invention. As can be seen from FIG. 1, battery apparatus 10 has much smaller dimensions than prior art lead acid batteries and weighs substantially less. Thus, it can be conveniently moved from a storage or non-working position to a position within a locomotive on a simple cart 12 or the like by a single employee. Also, cables and other equipment can be easily carried and stored on cart 12 for convenience of operation.

Battery apparatus 10 is carried in a case or housing 14, which may include convenient handles 16 for moving battery apparatus 10 from cart 12 or even in moving battery apparatus 10 with cart 12. Also, housing 14 includes a cover 18 so that the batteries and other circuitry are enclosed and protected. To provide the protection, housing 13 and cover 18 are preferably made of steel. A negative output terminal 20 and a positive output terminal 22 are mounted on cover 18 in a convenient location so they can be easily connected to a locomotive by interconnecting cables (not shown).

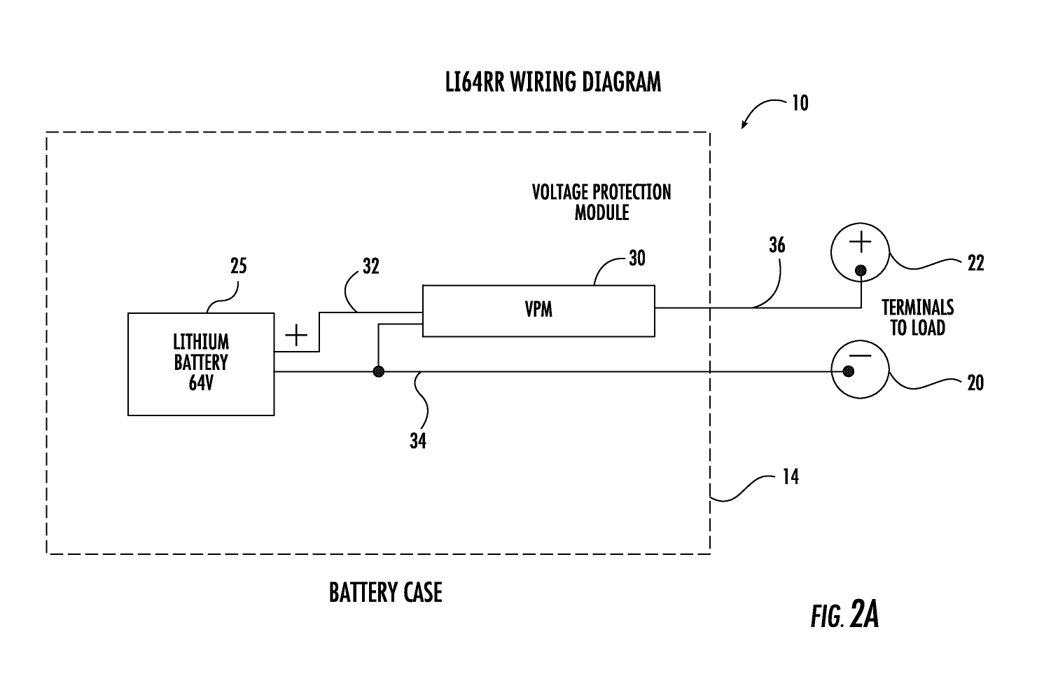

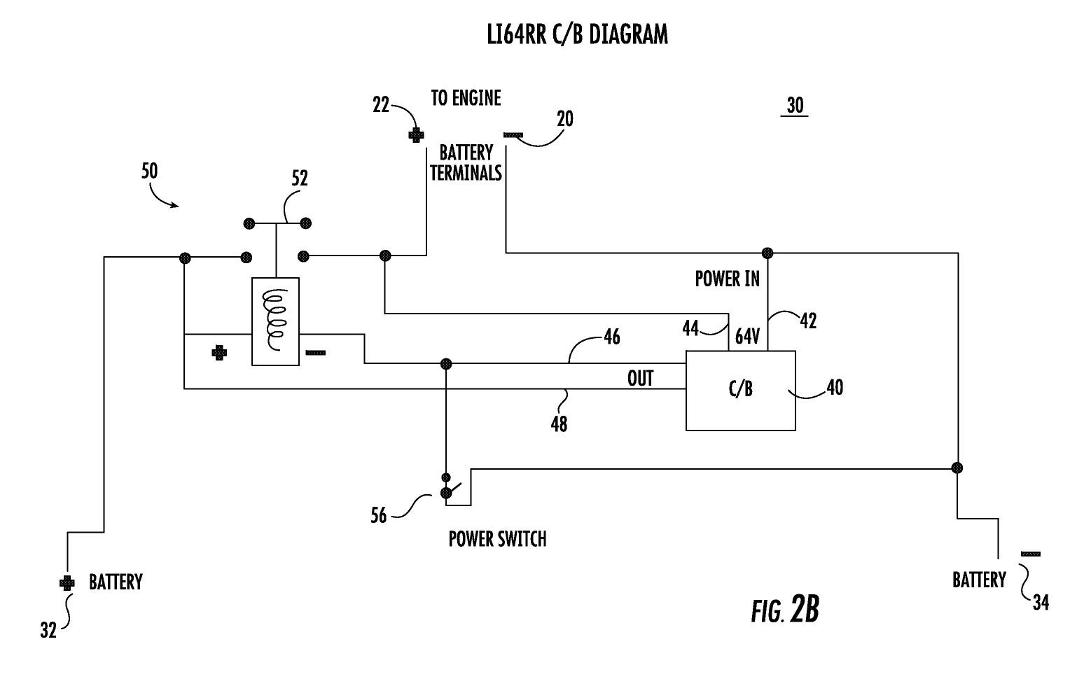

Turning additionally to FIG. 2A, a wiring diagram of Lithium ion battery apparatus 10 is illustrated. Battery apparatus 10 includes a single 64 volt Lithium ion battery unit 25 carried within housing 14. Lithium ion battery unit 25 is based on newly developed Lithium Iron Phosphate chemistry (LiFePO₄ or LEP). The newly developed Lithium iron phosphate technology has the features of safety, excellent cycle life, uncompromising performance, quick charge times, no or virtually no maintenance, and is environmentally friendly (i.e. contains no harmful heavy metals). Lithium ion battery unit 25 weighs approximately 170 pounds and has much smaller dimensions than prior art lead acid battery units. Because of the relatively light weight no heavy equipment is required for battery handling. Also, because of the relatively light weight and ease of handling, Lithium ion battery unit 25 can be sent back to a purveyor for replacement for less than the cost and effort of providing a new unit, which eliminates recycling issues.

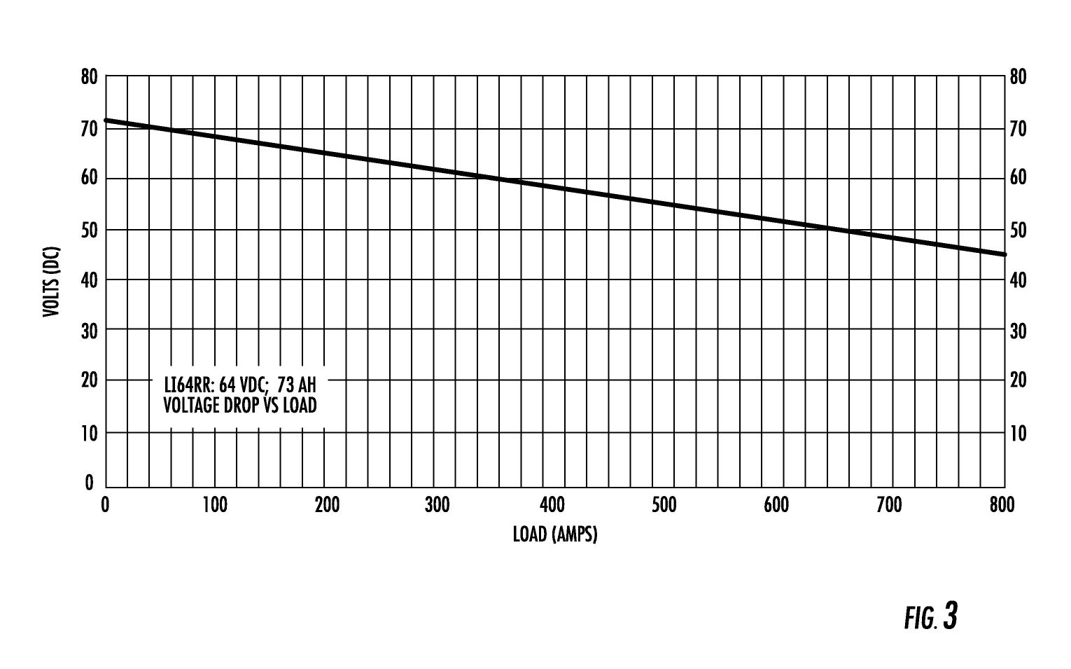

Lithium ion battery unit 25 is designed for regular deep cycle uses, which are undesirable in lead acid batteries. However, ‘deep discharges’ does not mean that Lithium ion battery unit 25 is drained to zero volts. Illustrated in FIG. 3 is a graphical presentation of the voltage drop versus load of Lithium ion battery unit 25. Lithium ion battery unit 25 has a minimum threshold voltage that should not be crossed. If unprotected and Lithium ion battery unit 25 is over discharged (i.e. the minimum threshold voltage is crossed), permanent damage to the cells will occur. This over discharge situation will not however, pose a safety hazard to operating personnel.

In the present application, Lithium ion battery unit 25 is protected from over discharge with a special voltage sensing internal circuit board 40. Circuit board 40 is contained within a voltage protection module (VPM) 30 connected to a positive output lead 32 and a negative output lead 34 to continually sense the output voltage when Lithium ion battery apparatus 10 is connected to a locomotive. Also, a positive output lead 36 is connected from module 30 to positive output terminal 22 of the pair of terminals 20 and negative output lead 34 continues on and is connected to negative output terminal 20. Circuit board 40 within module 30 essentially removes Lithium ion battery unit 25 from the locomotive circuit, i.e. switches the battery into a “sleeping mode” when the battery reaches a low voltage or a high voltage condition. In this preferred embodiment the pre-programmed low voltage condition is approximately 62 volts and the high voltage is approximately 79 volts.

Referring additionally to FIG. 2B the internal wiring of module 30 is illustrated in more detail. Circuit board 40 has an input terminal 42 coupled to the negative terminal 20/34 of battery 25 and an input terminal 44 coupled to positive output terminal 22 so that the output voltage of module 30 is continuously applied to the input of circuit board 40. Also, circuit board 40 has an output lead 46 connected to one power terminal of a solenoid type switch 50 and an output lead 48 connected to a second power terminal of solenoid type switch 50. Switch 50 has a contact 52 that completes a circuit from positive battery terminal 32 to positive output terminal 22 when power is applied to the terminals from leads 46 and 48. While a solenoid type switch is illustrated for simplicity it will be understood that any type of switch that operates as described can be utilized.

Circuit board 40 includes high and low voltage sensors which remove power (switches the battery into a “sleeping mode”) from leads 46 and 48 when a voltage below approximately 62 volts or a voltage above approximately 79 volts is sensed at input terminals 42 and 44. A reset button 56 is connected between negative output terminal 34 of battery 25 and output line 46 of circuit board 40. To reactivate Lithium ion battery 25, the operator simply pushes reset button 56, generally situated conveniently on the side of housing 14, for approximately 2 seconds. Reset button 56 temporarily connects lead 46 and the negative terminal of switch 50 to the negative terminal of battery 25, i.e. applies power to close switch 50. Once switch 50 closes power from battery 25 is again applied to output terminals 20 and 22, as well as input terminals 42 and 44 of circuit board 40. If the power is within the specified limits circuit board 40 maintains switch 50 closed. When voltage protection module 30 switches battery apparatus 10 into the “sleeping mode” the battery voltage will read approximately zero volts at input terminals 42 and 44 until push button 56 is used to reactivate the apparatus.

As indicated above, Lithium ion battery unit 25 is based on newly developed Lithium Iron Phosphate chemistry (LiFePO₄ or LEP). Some specifications for the newly developed Lithium iron phosphate technology include:
Lithium ion battery unit 25 are:
Dimensions—L 22″×W 19″×H 14″
Nominal voltage—64 volts
Capacity—72.8 Amp hours
Battery—4659.2 Watt hours
Cold Cranking Amps—1200 Amps
Peak Amps—2800 Amps for 5 seconds
Recommended Charge Cutoff—72-74 volts
Max steady charge rate—75 Amps
Embedded computer board—Programmed to shut off Battery if voltage drops below 62 volts for 90 consecutive seconds or rises above 79 volts.
Operating temperatures—120 F to −20 F

If Lithium ion battery apparatus 10 is colder than −20 F it may not “turn-over or start” the engine on the first attempt. The operator should try starting as normal and, if the engine doesn't start, wait 20-30 seconds and try again. Often times the load on the battery will generate enough internal battery heat to warm the battery to >−20 F and allow the battery to function normally. It should be noted that it does not harm the battery to store it at a temperature <−20 F. At temperatures colder than −20 F the battery charge and discharge performance will be inefficient but will not harm the battery.

Thus new and improved Lithium ion battery apparatus for starting railroad locomotives is disclosed. The Lithium ion battery apparatus for starting railroad locomotives is smaller than prior art batteries and is relatively easy to handle. Also, the Lithium ion battery apparatus for starting railroad locomotives has three to five times the life cycle of lead acid batteries and can be quickly recharged and/or changed and easily replaced in a matter of minutes. Further, the Lithium ion battery apparatus has the features of safety, excellent cycle life, uncompromising performance, quick charge times, no or virtually no maintenance, and is environmentally friendly (i.e. contains no harmful heavy metals).

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Battery apparatus for starting railroad locomotives comprising:
a portable housing;
a Lithium Iron Phosphate chemistry Lithium ion battery carried within the housing, the battery having a positive output lead and a negative output lead;
a low voltage and high voltage protection module positioned within the housing and connected to the positive output lead and the negative output lead, the module being constructed to switch the battery into a “sleeping mode” when the battery voltage reaches a low voltage condition or a high voltage condition; and
a pair of output terminals coupled to the positive output lead and the negative output lead, the output terminals mounted on an exterior surface of the housing in a location available to be connected to a locomotive by interconnecting cables.

2. Battery apparatus for starting railroad locomotives as claimed in claim 1 wherein the housing includes a cover for access to components carried within the housing and the pair of output terminals being mounted on the cover.

3. Battery apparatus for starting railroad locomotives as claimed in claim 1 wherein the Lithium ion battery is a single 64 volt Lithium ion battery unit.

4. Battery apparatus for starting railroad locomotives as claimed in claim 3 wherein the Lithium ion battery weighs approximately 170 pounds.

5. Battery apparatus for starting railroad locomotives as claimed in claim 3 wherein the low voltage condition of the Lithium ion battery is approximately 62 volts.

6. Battery apparatus for starting railroad locomotives as claimed in claim 5 wherein the low voltage protection module is programmed to switch the battery into the “sleeping mode” if the battery voltage drops below approximately 62 volts for approximately 90 consecutive seconds.

7. Battery apparatus for starting railroad locomotives as claimed in claim 3 wherein the high voltage condition of the Lithium ion battery is approximately 79 volts.

8. Battery apparatus for starting railroad locomotives as claimed in claim 6 wherein when the low voltage protection module switches the battery into the “sleeping mode” the battery voltage will read approximately zero volts until a push button on the housing is used to reactivate the apparatus.

9. Battery apparatus for starting railroad locomotives comprising:
a portable housing;
a Lithium Iron Phosphate chemistry Lithium ion battery carried within the housing, the Lithium ion battery including a single 64 volt Lithium ion battery unit, the battery having a positive output lead and a negative output lead;
a low voltage protection module positioned within the housing and connected to the positive output lead and the negative output lead, the module being constructed to switch the battery into a “sleeping mode” when the battery voltage reaches a low voltage condition of approximately 62 volts or a high voltage condition of approximately 79 volts; and
a pair of output terminals connected to the positive output lead and the negative output lead, the output terminals mounted on an exterior surface of the housing in a location available to be connected to a locomotive by interconnecting cables.

10. Battery apparatus for starting railroad locomotives as claimed in claim 9 wherein the low voltage protection module is programmed to switch the battery into the “sleeping mode” if the battery voltage drops below approximately 62 volts for approximately 90 consecutive seconds.

11. Battery apparatus for starting railroad locomotives as claimed in claim 9 wherein when the voltage protection module switches the battery into the “sleeping mode” the battery voltage will read approximately zero volts until a push button on the housing is used to reactivate the apparatus.

12. Battery apparatus for starting railroad locomotives as claimed in claim 9 wherein the Lithium ion battery weighs approximately 170 pounds.

13. A method of attaching battery apparatus to a railroad locomotive for starting the locomotive comprising the steps of:
providing battery apparatus including a portable housing, a Lithium Iron Phosphate chemistry Lithium ion battery carried within the housing, the battery having a positive output lead and a negative output lead, a low voltage and a high voltage protection module positioned within the housing and connected to the positive output lead and the negative output lead, the module being constructed to switch the battery into a “sleeping mode” when the battery voltage reaches a low voltage or a high voltage condition, and a pair of output terminals connected to the positive output lead and the negative output lead mounted on an exterior surface of the housing; and
connecting the battery apparatus to a locomotive by interconnecting cables coupled between the locomotive and the pair of output terminals.

14. A method as claimed in claim 13 wherein the voltage protection module is programmed to switch the battery into the “sleeping mode” if the battery voltage drops below approximately 62 volts for approximately 90 consecutive seconds.

15. A method as claimed in claim 13 wherein the voltage protection module is programmed to switch the battery into the “sleeping mode” if the battery voltage rises above approximately 79 volts.
